(19) United States
(12) Patent Application Publication
(10) Pub. No.: US 2003/0215197 A1
(43) Pub. Date: Nov. 20, 2003

(54) Combined optical and electrical transmission line

(76) Inventors: Jonathan N. Simon, Castro Valley, CA (US); Gary B. Gordon, Saratoga, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/146,512

(22) Filed: May 14, 2002

(51) Int. Cl. G02B 6/44

(52) U.S. Cl. 385/101

(57) ABSTRACT

The combined optical and electrical transmission line includes an optical fiber and an electrically-conductive sleeve that surrounds the optical fiber. The optical fiber transmits optical signals and the conductive sleeve conducts electrical signals or electrical power. The electrically-conductive sleeve may form part of an electrical transmission line having a characteristic impedance capable of transmitting a high-frequency electrical signal.

### BACKGROUND OF THE INVENTION

Optical fibers are typically used to transmit optical signals between optical elements. Electrical signals sometimes have to be transmitted between the same optical elements or to at least one of the optical elements. Electrically-conductive traces independent of the optical transmission path have traditionally been used for this. This adds complexity and expense to the apparatus in which the optical elements reside.

The conventional arrangement is especially inconvenient and expensive when the electrical signal is at a frequency above that which can be conveniently transmitted using conventional printed circuit board traces. Shielded or coaxial electrical transmission lines with low-loss dielectrics have to be used to transmit such an electrical signal.

What is needed, then, is a way to transmit the electrical signal together with the optical signal.

### SUMMARY OF THE INVENTION

The invention provides a combined optical and electrical transmission line that includes an optical fiber and an electrically-conductive sleeve that surrounds the optical fiber. The optical fiber transmits optical signals and the conductive sleeve conducts electrical signals or electrical power. Thus, the combined optical and electrical transmission line provides both an optical connection and an electrical connection in a single physical device.

The electrically-conductive sleeve may form part of an electrical transmission line having a characteristic impedance and capable of transmitting a high-frequency electrical signal with excellent pulse integrity.

The invention also provides a method of transmitting an optical signal and an electrical signal. In the method, an optical fiber is provided and conductive material is provided. The optical fiber is surrounded with the conductive material. An optical connection is made to the optical fiber and an electrical connection is made to the conductive material.

### BRIEF DESCRIPTION OF THE DRAWINGS

FIG. 1 is a cut-away perspective view of a short length of a first embodiment of a combined optical and electrical transmission line according to the invention.

FIG. 2 is a cut-away perspective view of a short length of a second embodiment of a combined optical and electrical transmission line according to the invention.

FIG. 3A is a cut-away perspective view of a short length of a third embodiment of a combined optical and electrical transmission line according to the invention.

FIG. 3B is a cut-away perspective view of a short length of a variation on the third embodiment of a combined optical and electrical transmission line according to the invention.

FIG. 4 is a cut-away perspective view of a short length of a fourth embodiment of a combined optical and electrical transmission line according to the invention.

FIG. 5A is a flow chart illustrating a method according to the invention for transmitting an optical signal and an electrical signal.

FIG. 5B is a flow chart showing a first variation on the method shown in FIG. 5A.

FIG. 5C is a flow chart showing a second variation on the method shown in FIG. 5A.

FIG. 5D is a flow chart showing a third variation on the method shown in FIG. 5A.

FIG. 5E is a flow chart showing a fourth variation on the method shown in FIG. 5A.

### DETAILED DESCRIPTION OF THE INVENTION

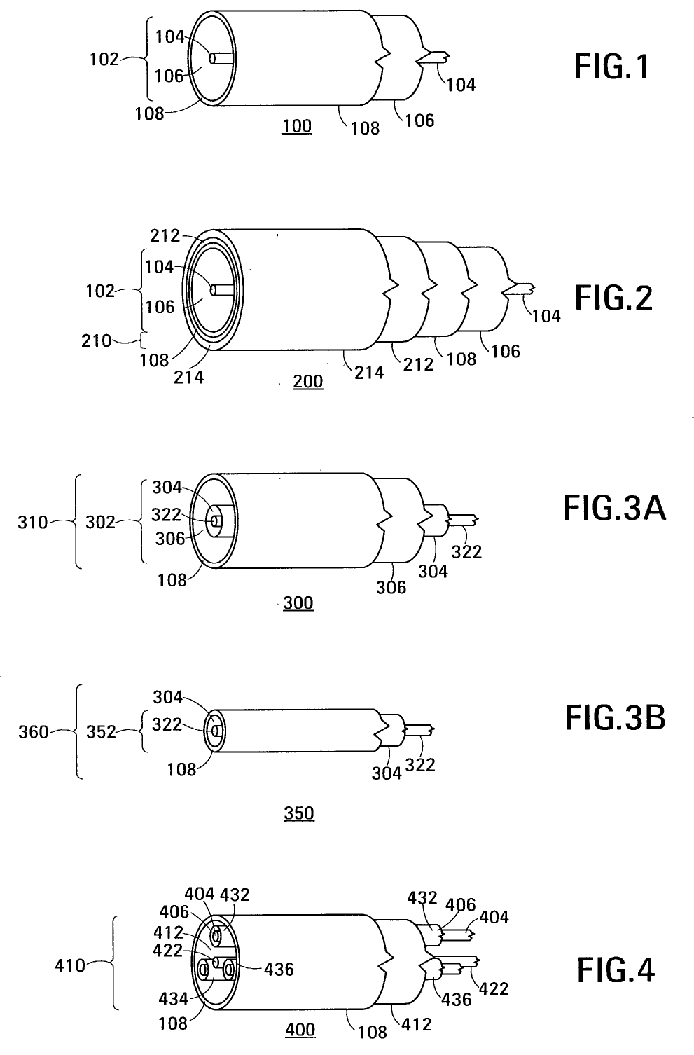

FIG. 1 shows a short length of a first embodiment 100 of a combined optical and electrical transmission line according to the invention. The combined optical and electrical transmission line 100 is composed of the optical fiber 102 and the conductive sleeve 108. The optical fiber is composed of the core 104 and the cladding 106. The cladding surrounds the core. The conductive sleeve 108 is electrically conductive, is substantially cylindrical in shape, surrounds the optical fiber 102 and is substantially concentric therewith, and extends over at least part of the length of the optical fiber. The conductive sleeve provides an electrically-conductive path that extends along the at least part of the length of the optical fiber 102. The conductive sleeve may be covered by additional protective and electrically-insulating layers (not shown) if necessary.

The conductive sleeve 108 provides an electrical connection and the optical fiber 102 provides an optical connection. The conductive sleeve may convey an electrical signal, AC power or DC power. The electrical signal may be an information signal, a control signal or some other form of signal. The AC or DC power may be used to power an opto-electronic device that is the source or destination of the optical signal conveyed by the optical fiber, for example. Multiple electrical signals, or signals and power, may be multiplexed by time division or frequency division multiplexing for transmission via the conductive sleeve.

The combined optical and electrical transmission line 100 is made by coating the cladding 106 of the optical fiber 102 with an electrically-conductive material, such as silver or copper, to form the conductive sleeve 108. Techniques for performing such coating are known in the art and will therefore not be described here. The combined optical and electrical transmission line 100 may alternatively made by wrapping conductive tape around the cladding 106. As a further alternative, the cladding may be surrounded by conductive braiding, as in a conventional coaxial cable to provide the conductive sleeve. Techniques for performing such wrapping or surrounding are known in the art and will therefore not be described.

Optical fiber connectors composed of a pair of optical fiber connector halves are known in the art. Such optical fiber connectors can be used to provide an optical connection between the combined optical and electrical transmission line 100 and an optical element (not shown). As will be described in detail below, an optical fiber connector made of a conductive material can additionally provide an electrical connection between the combined optical and electrical transmission line and the optical element or a nearby electronic component. One optical fiber connector half (not shown) of the optical fiber connector is fitted to one end of the combined optical and electrical transmission line 100. The other optical fiber connector half of the optical fiber connector is mounted on or adjacent the optical element. The combined optical and electrical transmission line is then connected to the optical element by mating the halves of the optical fiber connector. Mating the halves of the optical fiber connector establishes at least an optical connection between the combined optical and electrical transmission line and the optical element.

A conductive optical fiber connector made of, or including, a conductive material additionally provides an electrical connection between the combined optical and electrical transmission line 100 and the optical element or a nearby electronic component. An optical element that is an electro-optical element, such as a light-emitting device or a light detector, includes at least one electrical connection. The conductive optical fiber connector half fitted to the combined optical and electrical transmission line is electrically connected to the conductive sleeve 108. The conductive optical fiber connector half mounted on the optical element is additionally electrically connected to the optical element or to a nearby electronic component.

Mating the halves of the conductive optical fiber connector provides an optical connection between the combined optical and electrical transmission line 100 and the optical element, as described above. Mating the halves of the conductive optical fiber connector additionally provides an electrical connection between the conductive sleeve 108 of the combined optical and electrical transmission line and the optical element or the nearby electronic component. Thus, mating the halves of the optical fiber connector establishes both an optical connection and an electrical connection between the combined optical and electrical transmission line and the optical element.

FIG. 2 shows a short length of a second embodiment 200 of a combined optical and electrical transmission line according to the invention. The combined optical and electrical transmission line 200 includes the coaxial electrical transmission line 210 surrounding the optical fiber 102. Elements of the combined optical and electrical transmission line 200 that correspond to the combined optical and electrical transmission line 100 described above with reference to FIG. 1 are indicated using the same reference numerals and will not be described again here.

In the combined optical and electrical transmission line 200, the conductive sleeve 108 is an inner conductive sleeve. The combined optical and electrical transmission line is additionally composed of the dielectric sleeve 212 surrounding the inner conductive sleeve 108, and the outer conductive sleeve 214 surrounding the dielectric sleeve 212. The outer conductive sleeve 214 may be covered by additional protective and electrically-insulating layers, as described above.

The inner conductive sleeve 108, the dielectric sleeve 212 and the outer conductive sleeve 214 collectively constitute the coaxial electrical transmission line 210. The coaxial transmission line is structured as is known in the art to have a characteristic impedance, for example, 50 Ω, that matches the characteristic impedance of source and destination electronic circuits interconnected by the combined optical and electrical transmission line 200. The coaxial electrical transmission line is capable of transmitting a high-speed electrical signal, maintaining pulse integrity and providing impedance matching to the source and destination electronic circuits. The electrical signal is connected to the inner conductive sleeve 108 and the outer conductive sleeve 214 is connected to ground. The conductive sleeves 108 and 214 may convey one or more of DC power, AC power and other electrical signals multiplexed with, or instead of, the above-mentioned electrical signal.

A conductive optical fiber connector similar to the conductive optical fiber connector described above can be used to provide both an optical connection and an electrical connection from the combined optical and electrical transmission line 200 to an optical element or to a nearby electronic circuit. The optical fiber connector is modified, however, to provide electrical connections to both the inner conductive sleeve 108 and the outer conductive sleeve 214 of the combined optical and electrical transmission line 200. Moreover, the electrical connections provided by the conductive optical fiber connector have the same characteristic impedance as the coaxial electrical transmission line 210.

The combined optical and electrical transmission line 200 is made by coating the cladding 106 of the optical fiber 102 with an electrically-conductive material, such as silver or copper, to form the inner conductive sleeve 108. The inner conductive sleeve is then coated with a low-loss dielectric material, such as poly-tetrafluoroethylene (PTFE), to form the dielectric sleeve 212. The dielectric sleeve is then coated with an electrically-conductive material, such as silver or copper, to form the outer conductive sleeve 214. Techniques for performing the above-mentioned coating operations are known in the art and will therefore not be described here.

Either or both of the inner conductive sleeve 108 and the outer conductive sleeve 214 may alternatively be made by wrapping conductive tape around the cladding 106 or the dielectric sleeve 212, respectively. As a further alternative, either or both of the inner conductive sleeve and the outer conductive sleeve may be made by surrounding the cladding or the dielectric sleeve, respectively, with conductive braiding. Techniques for performing such wrapping and surrounding are known in the art and will therefore not be described.

FIG. 3A shows a short length of a third embodiment 300 of a combined optical and electrical transmission line according to the invention. The combined optical and electrical transmission line 300 includes the optical fiber 302 and the coaxial electrical transmission line 310. The structure of the coaxial electrical transmission line 300 differs from that of the coaxial electrical transmission line 210 described above with reference to FIG. 2 in that the optical fiber 308 forms at least part of the dielectric sleeve of the coaxial electrical transmission line 310. Elements of the combined optical and electrical transmission line 300 that correspond to the combined optical and electrical transmission line 100 described above with reference to FIG. 1 are indicated using the same reference numerals and will not be described again here.

The combined optical and electrical transmission line 300 is composed of the center conductor 322, the optical fiber core 304 surrounding the center conductor, the optical fiber cladding 306 surrounding the optical fiber core and the conductive sleeve 108 surrounding the optical fiber cladding 306. The center conductor, the optical fiber core, the optical fiber cladding and the conductive sleeve are substantially concentric. The conductive sleeve 108 may be covered by additional protective and electrically-insulating layers, as described above.

The optical fiber core 304 and the optical fiber cladding 306 constitute the optical fiber 302. The optical fiber core and the optical fiber cladding are formed of optically-transparent materials with the material of the optical fiber cladding 306 having a slightly smaller refractive index than that of the optical fiber core 304.

The center conductor 322, the optical fiber 302 and the conductive sleeve 108 constitute the center conductor, the dielectric and the outer conductor, respectively, of the coaxial electrical transmission line 310. The coaxial electrical transmission line is capable of transmitting a high-speed electrical signal, maintains pulse integrity and has a characteristic impedance that provides impedance matching to source and destination electronic circuits. The electrical signal is connected to the center conductor 322 and the conductive sleeve 108 is connected to ground. The center conductor 322 and the conductive sleeve 108 may additionally or alternatively convey one or more of AC power, DC power or and other electrical signals.

The center conductor 322 is an elongate prism of conductive material. The conductive material of the center conductor may be the same as, or may be different from, the conductive material of the conductive sleeve 108.

An additional sleeve (not shown) of dielectric material may be interposed between the optical fiber 302 and the conductive sleeve 108. Such additional sleeve may be used to provide the coaxial electrical transmission line 310 with a specific characteristic impedance, for example. In this case, the optical fiber constitutes only part of the dielectric sleeve of the coaxial electrical transmission line 310. Such additional sleeve may be used to provide the coaxial electrical transmission line 310 with a specific characteristic impedance, for example.

The combined optical and electrical transmission line 300 is made by first making the optical fiber 302 surrounding the center conductor 322. Techniques are known for forming a capillary of glass or plastic. The center conductor 322 is inserted into a glass or plastic capillary to surround the center conductor with a sleeve of glass or plastic. Alternatively, a similar structure can be made using by extrusion.

The center conductor 322 and the glass or plastic sleeve are heated to form the optical fiber 302 in the material of the sleeve. In an embodiment, the heating is performed in an atmosphere of hydrogen. Heating the center conductor and the sleeve causes the conductive material of the center conductor to diffuse radially outwards into the material of the sleeve. The conductive material diffused into the sleeve increase the refractive index of the material of the sleeve to form the optical fiber core 304. The heating process additionally causes the hydrogen to diffuse radially inwards into the material of the sleeve. The hydrogen decreases the refractive index of the material of the sleeve to form the optical fiber cladding 306. The heating process is stopped when the optical fiber core and the optical fiber cladding are juxtaposed.

The optical fiber 302 is then coated with a layer of conductive material, as described above, to form the conductive sleeve 108. The optical fiber may alternatively be wrapped with conductive tape or surrounded with conductive braiding, as described above, to form the conductive sleeve.

FIG. 3B shows a short length of a combined optical and electrical transmission line 350 according to the invention. The combined optical and electrical transmission line is a simplified variation on the combined optical and electrical transmission line 300 described above with reference to FIG. 3A suitable for medium speed, short distance applications. Elements of the combined optical and electrical transmission line 350 that correspond to the combined optical and electrical transmission line 300 described above with reference to FIG. 3A are indicated using the same reference numerals and will not be described again here.

The combined optical and electrical transmission line 350 is composed of the center conductor 322, the optical fiber core 304 surrounding the center conductor and the conductive sleeve 108 surrounding the optical fiber core 304. The center conductor, the optical fiber core and the conductive sleeve are substantially concentric. The conductive sleeve 108 may be covered by additional protective and electrically-insulating layers, as described above.

The optical fiber core 304 and the conductive sleeve 108 constitute the optical fiber 352. The optical fiber core and the conductive sleeve collectively provide enough of an optical waveguide for short-distance applications.

The center conductor 322, the optical fiber core 304 and the conductive sleeve 108 constitute the center conductor, the dielectric and the outer conductor, respectively, of the coaxial electrical transmission line 360. The coaxial electrical transmission line is capable of transmitting a high-speed electrical signal, maintains pulse integrity and has a characteristic impedance that provides impedance matching to source and destination electronic circuits. The electrical signal is connected to the center conductor 322 and the conductive sleeve 108 is connected to ground. The center conductor 322 and the conductive sleeve 108 may additionally or alternatively convey one or more of AC power, DC power and other electrical signals.

An additional sleeve (not shown) of dielectric material may be interposed between the optical fiber core 304 and the conductive sleeve 108 to provide the coaxial electrical transmission line 360 with a specific characteristic impedance, for example. In this case, the optical fiber core constitutes only part of the dielectric sleeve of the coaxial electrical transmission line.

The method described above with referenced to FIG. 3A for making the combined optical and electrical transmission line 300 may be adapted to make the combined optical and electrical transmission line 350. The combined optical and electrical transmission line 350 may alternatively be made using some other method.

FIG. 4 shows a short length of a fourth embodiment 400 of a combined optical and electrical transmission line according to the invention. The combined optical and electrical transmission line 400 is composed of a coaxial electrical transmission line having multiple optical fibers embedded in its dielectric sleeve. Elements of the combined optical and electrical transmission line 400 that correspond to the combined optical and electrical transmission line 100 described above with reference to FIG. 1 are indicated using the same reference numerals and will not be described again here.

The combined optical and electrical transmission line 400 is composed of the center conductor 422, the dielectric sleeve 412 surrounding the center conductor and the conductive sleeve 108 surrounding the dielectric sleeve. The center conductor, the dielectric sleeve and the conductive sleeve are arranged substantially concentrically with one another and constitute the coaxial electrical transmission line 410. The conductive sleeve may be covered by additional protective and electrically-insulating layers, as described above.

At least one optical fiber is embedded in the dielectric sleeve 412 of the coaxial electrical transmission line 410. In the example shown, the optical fibers 432, 434 and 436 are embedded in the dielectric sleeve. The optical fiber 432 is composed of the cladding 406 and the core 404, which has a higher refractive index than the cladding. The cladding surrounds the core. The optical fibers 432 and 436 are similarly structured. The number of optical fibers shown is merely exemplary: more or fewer optical fibers may be embedded in the dielectric sleeve.

The coaxial electrical transmission line 410 is capable of transmitting a high-speed electrical signal, maintains pulse integrity and has a characteristic impedance matched to that of source and destination electronic circuits. The electrical signal is connected to the center conductor 422 and the conductive sleeve 108 is connected to ground. The center conductor 422 and the conductive sleeve 108 may additionally or alternatively convey one or more of AC power, DC power and other electrical signals.

The combined optical and electrical transmission line 400 is made using an extrusion process to surround the center conductor 422 with the dielectric sleeve 412 in which at least one optical fiber, e.g., optical fiber 432, is embedded. The dielectric sleeve 412 is coated with a conductive material, as described above, to provide the conductive sleeve 108. The dielectric sleeve may alternatively be wrapped with conductive tape or surrounded with conductive braiding as described above provide the conductive sleeve 108.

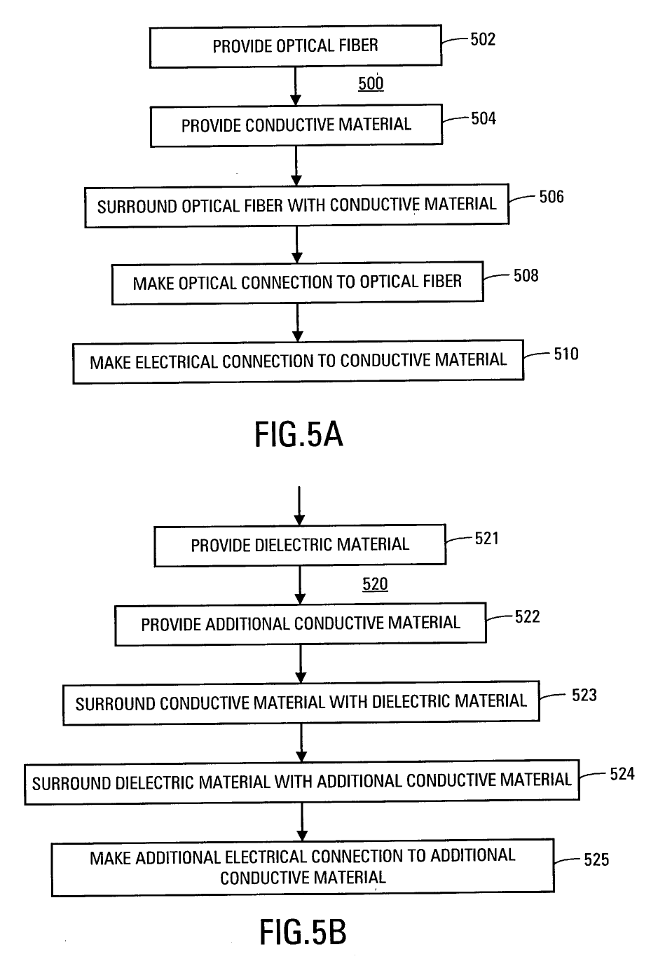

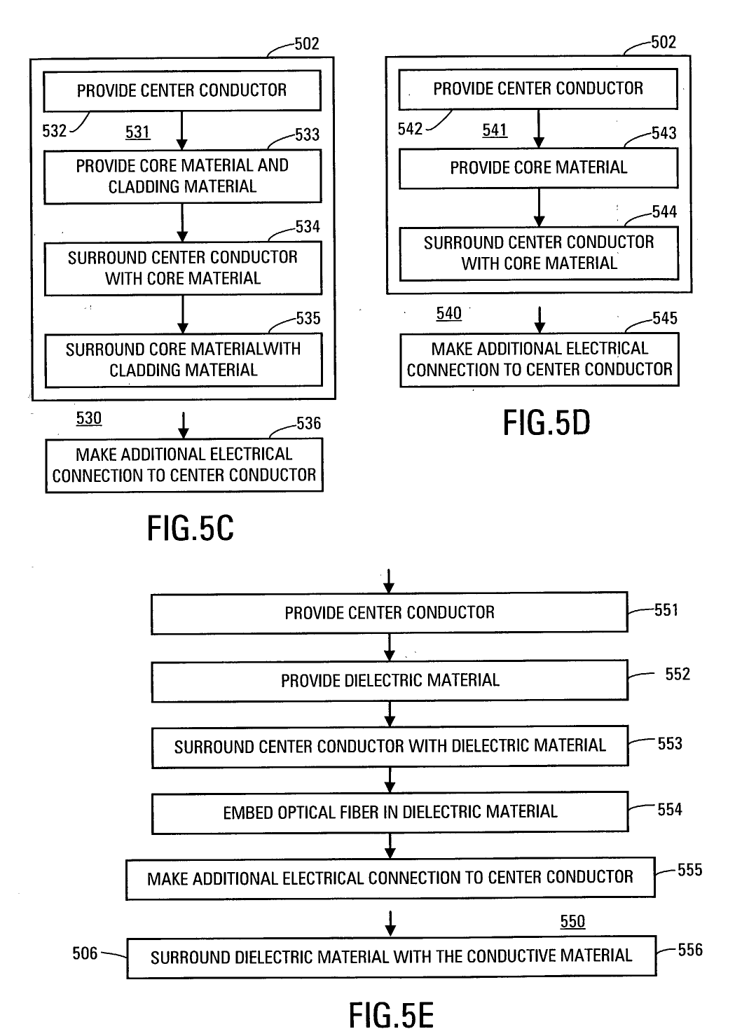

A method 500 according to the invention for transmitting an optical signal and an electrical signal will now be described with reference to the flow chart shown in FIG. 5A.

In process 502, an optical fiber is provided.

In process 504, conductive material is provided.

In process 506, the optical fiber is surrounded with the conductive material.

In process 508, an optical connection is made to the optical fiber.

In process 510, an electrical connection is made to the conductive material.

In process 506, the optical fiber may be surrounded with the conductive material by coating the optical fiber with the conductive material.

FIG. 5B is a flow chart showing a first variation 520 on the method described above with reference to FIG. 5A. The variation includes additional processes 521-525.

In process 521, dielectric material is provided.

In process 522, additional conductive material is provided. The additional conductive material may be the same as, or different from, the conductive material provided in process 504.

In process 523, the conductive material is surrounded with the dielectric material.

In process 524, the dielectric material is surrounded with the additional conductive material.

In process 525, an additional electrical connection is made to the additional conductive material.

FIG. 5C is a flow chart showing a second variation 530 on the method described above with reference to FIG. 5A. The variation includes an embodiment 531 of process 502 and an additional process 536.

The embodiment 531 of process 502 is composed of processes 532-535.

In process 532, a center conductor is provided.

In process 533, core material and cladding material are provided.

In process 534, the center conductor is surrounded with the core material.

In process 535, the core material is surrounded with the cladding material.

In process 536, an additional electrical connection made to the center conductor.

FIG. 5D is a flow chart showing a third variation 540 on the method described above with reference to FIG. 5A. The variation includes an embodiment 541 of process 502 and an additional process 545.

The embodiment 541 of process 502 is composed of processes 542-544.

In process 542, a center conductor is provided.

In process 543, core material is provided.

In process 544, the center conductor is surrounded with the core material.

In process 545, an additional electrical connection made to the center conductor.

FIG. 5E is a flow chart showing a fourth variation 550 on the method described above with reference to FIG. 5A. The variation includes additional processes 551-555 and an embodiment 556 of process 506.

In process 551, a center conductor is provided.

In process 552, dielectric material is provided.

In process 553, the center conductor is surrounded with the dielectric material.

In process 554, the optical fiber is embedded in the dielectric material.

In process 555, an additional electrical connection is made to the center conductor.

In the embodiment 556 of process 506, the dielectric material in which the optical fiber is embedded is surrounded by the conductive material to surround the optical fiber with the conductive material.

In a further variation, in process 554, at least one additional optical fiber may be provided and embedded in the dielectric material.

This disclosure describes the invention in detail using illustrative embodiments. However, it is to be understood that the invention defined by the appended claims is not limited to the precise embodiments described.

We claim:

1. A combined optical and electrical transmission line, comprising:
an optical fiber, and
an electrically-conductive sleeve surrounding the optical fiber.

2. The combined optical and electrical transmission line of claim 1, in which:
the optical fiber includes a core and a cladding, the cladding surrounding the core; and
the electrically-conductive sleeve is in contact with the cladding.

3. The combined optical and electrical transmission line of claim 1, in which:
the conductive sleeve is an inner conductive sleeve; and
the combined optical and electrical transmission line additionally comprises:
a dielectric sleeve surrounding the inner conductive sleeve, and
an outer conductive sleeve surrounding the dielectric sleeve, the inner conductive sleeve, the dielectric sleeve and the outer conductive sleeve constituting a coaxial electrical transmission line having a characteristic impedance.

4. The combined optical and electrical transmission line of claim 1, in which:
the optical fiber includes a core and a cladding, the cladding surrounding the core; and
the combined optical and electrical transmission line additionally comprises an inner conductor surrounded by the core of the optical fiber, the inner conductor, the optical fiber and the conductive sleeve constituting a coaxial electrical transmission line having a characteristic impedance.

5. The combined optical and electrical transmission line of claim 1, in which:
the optical fiber includes a core and a cladding, the cladding surrounding the core; and
the conductive sleeve constitutes the cladding of the optical fiber.

6. The combined optical and electrical transmission line of claim 1, in which:
the combined optical and electrical transmission line additionally comprises a center conductor and a dielectric arranged substantially concentric with, and surrounded by, the conductive sleeve, the center conductor, the dielectric and the conductive sleeve collectively constituting a coaxial electrical transmission line having a characteristic impedance; and
the optical fiber is embedded in the dielectric.

7. The combined optical and electrical transmission line of claim 4, additionally comprising at least one additional optical fiber embedded in the dielectric.

8. The combined optical and electrical transmission line of claim 1, additionally comprising a conductive optical fiber connector half in optical communication with the optical fiber and electrically connected to the conductive sleeve.

9. A method of transmitting an optical signal and an electrical signal, the method comprising:
providing an optical fiber;
providing conductive material;
surrounding the optical fiber with the conductive material;
making an optical connection to the optical fiber; and
making an electrical connection to the conductive material.

10. The method of claim 9, in which surrounding the optical fiber with the conductive material includes coating the optical fiber with the conductive material.

11. The method of claim 9, additionally comprising:
providing a dielectric material;
providing additional conductive material;
surrounding the conductive material with the dielectric material;
surrounding the dielectric material with the additional conductive material; and
making an additional electrical connection to the additional conductive material.

12. The method of claim 9, in which:
providing an optical fiber includes:
providing a center conductor,
providing core material and cladding material,
surrounding the center conductor with the core material, and
surrounding the core material with the cladding material; and
the method additionally comprises making an additional electrical connection to the center conductor.

13. The method of claim 9, in which:
providing an optical fiber includes:
providing a center conductor,
providing core material, and
surrounding the center conductor with the core material; and
the method additionally comprises making an additional electrical connection to the center conductor.

14. The method of claim 9, in which:
the method additionally comprises:
providing a center conductor,
providing dielectric material,
surrounding the center conductor with the dielectric material,
embedding the optical fiber in the dielectric material, and
making an additional electrical connection to the center conductor; and
surrounding the optical fiber with the conductive material includes surrounding the dielectric material with the conductive material.

15. The method of claim 14, additionally comprising:
providing at least one additional optical fiber; and
embedding the at least one additional optical fiber in the dielectric material.
